(19) United States
(12) Patent Application Publication
(10) Pub. No.: US 2012/0065282 A1
(43) Pub. Date: Mar. 15, 2012

(54) METHOD FOR PREPARING POLYAMIDE FOAM AND FOAM CAPABLE OF BEING PRODUCED BY SAID METHOD

(75) Inventors: Lise Trouillet-Fonti, Villette De Vienne (FR); Eric Roche, Luzinay (FR)

(73) Assignee: RHODIA OPERATIONS, Aubervilliers (FR)

(21) Appl. No.: 13/320,718

(22) PCT Filed: May 10, 2010
(86) PCT No.: PCT/EP10/56361

§ 371 Date: Nov. 30, 2011

(30) Foreign Application Priority Data
May 15, 2009 (FR) 0953224

(51) Int. Cl. C08L 77/06; C08J 9/228; C08L 75/04; C08J 9/35

(52) U.S. Cl. 521/59; 521/137

(57) ABSTRACT

A method for preparing polyamide foam is described. Polyamide foam produced according to the method is also described. A method including heating a composition including at least one polyamide and at least one polyurethane, and stabilizing the resulting cellular structure is also described. Use of a composition including at least one polyamide and at least one polyurethane for preparing polyamide foam is also described.

The present invention relates to a process for the preparation of polyamide foam and to a polyamide foam capable of being obtained according to this process.

Synthetic foams are used in many fields, such as thermal or sound insulation, motor vehicle trim, and the like.

Essentially two types of foam are distinguished: structural foams and nonstructural foams.

Structural foams are rigid foams composed of a low-density core and of a skin, the density of which is similar to that of the polymer making up the matrix. These foams can be used as lighter structures in the aeronautical or motor vehicle field, for example.

Nonstructural foams can be flexible or rigid. The rigid foams are used in the field of thermal insulation (the gas present in the cells acts as insulator). The flexible foams are used in the fields of furniture and motor vehicle trim, for their compressibility and damping properties, in the packaging field, due to their low weight, and in the field of sound insulation (the foams exhibiting an open porosity have the distinguishing feature of absorbing certain frequencies).

Various methods are known for producing thermoplastic polymer foams, such as polystyrene, PVC, polyethylene or polypropylene foams, and the like.

It is known to inject pressurized gases into the molten polymer.

It is also known to incorporate pore-forming agents (thermally unstable fillers) in the molten polymer, which release a gas during their decomposition. It is sometimes difficult to control this method and the cells generated may then be irregular in size.

It is also possible to introduce, into the molten polymer, compounds dissolved in the melt, the foam being obtained by a volatilization of these compounds.

Finally, it is known to obtain foams using a chemical reaction in which gas, such as carbon dioxide, is released. This is the case, for example, with polyurethane foams obtained by reaction between isocyanates, polyols and water, resulting in the formation of polyurethane with the release of carbon dioxide.

Polyamide foams can also be obtained chemically, by bringing together isocyanates and lactams, and also bases, in order to activate the anionic polymerization.

The present invention provides another chemical route for the preparation of polyamide foams, starting from a composition comprising at least one polyamide and at least one polyurethane. It is simple to prepare the composition and the foam; the foam can be obtained in situ without having to introduce external agents, directly from the composition, and using conventional equipment. The process for preparation of the foam makes it possible in particular to control the foaming reaction. This process is also flexible: this is because foams of varied nature and with varied properties can be obtained by this process, in particular by the appropriate choice of the nature and characteristics of the polyamide and polyurethane of the composition.

The invention provides a process for the preparation of a polyamide foam comprising at least the following stages:
a) Heating a composition comprising at least the following compounds:
   A: a polyamide
   B: a polyurethane
   optionally C: a compound comprising at least one acid functional group, preferably a carboxylic acid functional group,
      at a temperature greater than or equal to the melting point of the polyamide A of the composition,
b) Stabilizing the cellular structure obtained.

The invention also provides a polyamide foam capable of being obtained by this process.

Finally, the invention provides for the use of a composition as described above to prepare a polyamide foam.

The polyurethane B of the composition comprises urethane functional groups; it is capable of releasing isocyanate functional groups under the effect of the temperature.

The term “acid functional group” is understood to mean any acid functional group which can, by reaction with an isocyanate functional group, make possible release of gas, generally carbon dioxide; mention may be made, by way of example, of the carboxylic acid, phosphoric acid or sulfonic acid functional groups, and the like. However, carboxylic acid functional groups are preferred. The term “acid functional group” is also understood to mean the functional groups derived from the acid functional group, such as the acid anhydride, acid chloride or ester functional group, and the like. These derived functional groups result either directly in release of gas, generally carbon dioxide, by reaction under hot conditions with the isocyanate functional group, or indirectly, after reaction of the derived functional groups with a compound which regenerates acid functional groups; mention may be made, as an example of a derived functional group which can result in release of gas indirectly, of the acid chloride functional group or the carboxylic acid anhydride functional group, for which the carboxylic acid functional group can be regenerated by reaction with water.

Compound C of the composition comprises at least one acid functional group. The polyamide of the invention A generally also comprises carboxylic acid functional groups; these functional groups can be present at the terminal ends of the polyamide and/or distributed along the polyamide chain.

The polyurethane B of the invention can also comprise acid functional groups, in particular carboxylic acid functional groups.

These carboxylic acid functional groups are capable of reacting with the isocyanate functional groups of the polyurethane B according to the following reaction:

R₁—N═C═O+R₂—COOH→R₁—NH—CO—O—CO—R₂→R₁—NH—CO—R₂+CO₂

Generally, the expandable composition of the invention comprises a certain amount of acid functional groups and isocyanate functional groups, the reaction of which results in release of gas, in particular of carbon dioxide, during the preparation of the foam from the expandable composition.

Other mechanisms may also be involved during the preparation of the foam. In particular, the water contributed by the polyamide A of the composition can react with the isocyanate functional groups of the polyurethane B according to the following reaction:

R₁—N═C═O+H₂O→R₁—NH₂+CO₂

Acid functional groups can be contributed by the polyamide A alone, by the polyurethane B alone, by the compound C alone, by any two of these compounds A, B and C, or by the three compounds A, B and C.

The polyamide A of the invention is a polyamide of the type of those obtained by polycondensation from dicarboxylic acids and diamines, or of the type of those obtained by polycondensation of lactams and/or amino acids. The polyamide of the invention can be a blend of polyamides of different types and/or the same type, and/or copolymers obtained from different monomers corresponding to the same type and/or to different types of polyamide.

The polyamide A of the invention advantageously exhibits a number-average molecular weight of greater than or equal to 10 000 g/mol, preferably of greater than or equal to 14 000 g/mol and more preferably still of greater than or equal to 17 000 g/mol.

Mention may be made, as an example of a polyamide which may be suitable for the invention, of polyamide 6, polyamide 6,6, polyamide 11, polyamide 12, polyamides 4,6; 6,10; 6,12; 12,12 and 6,36; semiaromatic polyamides, polyphthalamides obtained from terephthalic and/or isophthalic acid, such as the polyamide sold under the Amodel trade name, copolyamide 6,6/6,T, and their copolymers and alloys.

According to a preferred embodiment of the invention, the polyamide is chosen from polyamide 6, polyamide 6,6, and their blends and copolymers. Advantageously, the polyamide is polyamide 6,6.

According to a specific alternative form of the invention, the polyamide A of the invention is a linear polyamide.

According to another specific alternative form of the invention, the polyamide A of the invention comprises star-shaped or H-shaped macromolecular chains and, if appropriate, linear macromolecular chains. The polymers comprising such star-shaped or H-shaped macromolecular chains are, for example, described in the documents FR 2 743 077, FR 2 779 730, U.S. Pat. No. 5,959,069, EP 0 632 703, EP 0 682 057 and EP 0 832 149.

According to another specific alternative form of the invention, the polyamide A of the invention is a copolyamide exhibiting a random tree structure. These copolyamides with a random tree structure and their process of preparation are described in particular in the document WO 99/03909.

According to a specific embodiment of the invention, the polyamide A of the invention can be a polyamide of low viscosity, such as described in the document WO 2008/107314.

The polyamide A of the invention can also be a composition comprising a linear polyamide and, as additive, a star-shaped, H-shaped and/or tree polyamide as described above.

The polyamide A of the invention can also be a composition comprising, as additive, a hyperbranched copolyamide of the type of those described in the document WO 00/68298.

The polyamide A can optionally comprise other functional groups, such as ester and/or urea and/or ether functional groups, and the like.

The polyurethane B of the invention is a polymer which is generally obtained from a diisocyanate, a polyol and optionally a short-chain diol.

Examples of diisocyanates which can be used in the preparation of the polyurethane are isophorone diisocyanate, 1,3- and 1,4-cyclohexane diisocyanate, 1,2-ethylene diisocyanate, 1,4-tetramethylene diisocyanate, 1,6-hexamethylene diisocyanate, 2,2,4- and 2,4,4-trimethyl-1,6-hexamethylene diisocyanate, 1,12-dodecane diisocyanate, α,α′-diisocyanatodipropyl ether, 1,3-cyclobutane diisocyanate, 2,2- and 2,6-diisocyanato-1-methylcyclohexane, 2,5 and 3,5-bis(isocyanatomethyl)-8-methyl-1,4-methanodecahydro-naphthalene, 1,5-, 2,5-, 1,6- and 2,6-bis(iso-cyanatomethyl)-4,7-methanohexahydroindane, 1,5-, 2,5- and 2,6-bis(isocyanato)-4,7-methanehexahydroindane, 2,4′- and 4,4′-dicyclohexyl diisocyanate, 2,4- and 2,6-hexahydrotolylene diisocyanate, perhydro-2,4′- and 4,4′-diphenylmethane diisocyanate, α,α′-diisocyanato-1,4-diethylbenzene, 1,3- and 1,4-phenylene diisocyanate, 4,4′-diisocyanatobiphenyl, 4,4′-diisocyanato-3,3′-dichlorobiphenyl, 4,4′ diisocyanato-3,3′-dimethoxy-biphenyl, 4,4′-diisocyanato-3,3′-dimethylbiphenyl, 4,4′-diisocyanato-3,3′-diphenylbiphenyl, 2,4′- and 4,4′-diisocyanatodiphenylmethane, naphthalene 1,5-diisocyanate, 2,4- and 2,6-toluene diisocyanate, N,N′-(4,4′-dimethyl-3,3′-diisocyanatodiphenyl)uretdione, m-xylylene diisocyanate, dicyclohexylmethane diisocyanate, tetramethylxylylene diisocyanate, and the analogs and mixtures.

The polyol used for the preparation of the polyurethane is generally a polyester, a polycaprolactone or a polyether.

The polyesters result from the condensation of a dicarboxylic acid, generally adipic acid, with a diol. Mention may be made, as an example of polyester, of poly(butanediol adipate), poly(hexanediol adipate), poly(ethanediol/butanediol adipate), and the like.

The polycaprolactones are polyesters resulting from the polymerization of ε-caprolactone and diols.

Mention may be made, as an example of polyether, of poly(ethylene glycol) (PEG), poly(propylene glycol) (PPG), poly(tetramethylene glycol) (PTMG), and the like.

The short-chain diol which can be used for the preparation of the polyurethane can, for example, be hexanediol or butanediol, or an aromatic diol.

The polyurethane is advantageously a thermoplastic polyurethane.

The polyurethane can be aromatic or aliphatic, depending on the aromatic or aliphatic nature of the diisocyanate used to prepare it. Advantageously, the polyurethane of the invention is aliphatic.

The polyurethane of the invention can be a mixture of several different polyurethanes.

According to a specific embodiment of the invention, the polyurethane exhibits a number-average molecular weight of greater than or equal to 2000 g/mol.

Advantageously, it exhibits a number-average molecular weight of greater than or equal to 5000 g/mol, preferably of greater than or equal to 10 000 g/mol and more preferably still of greater than or equal to 13 000 g/mol.

The compound C comprising at least one acid functional group is preferably a polyacid, that is to say a compound comprising at least two acid functional groups. It is possible to use mixtures of different compounds C.

The compound C can also be a compound comprising an acid functional group and another functional group which reacts with the carboxyl or amine functional group of the polyamide. Mention may thus be made, by way of example of reactive functional group, of primary or secondary amine, alcohol or mercapto functional groups, and the like. Mention may be made, as an example of such compound C, of citric acid. The preferred reactive functional groups are primary or secondary amine functional groups.

The compound C can also be a compound comprising an acid functional group and another functional group which does not react with the carboxyl or amine functional group of the polyamide. Mention may thus be made, as example of unreactive functional group, of sulfonate or phosphonate functional groups, and the like. Mention may be made, as example of such compound C, of the sodium salt of 3-sulfobenzoic acid and the potassium salt of 4-sulfobenzoic acid.

The compound C of the invention is preferably a dicarboxylic acid. Mention may be made, as example of dicarboxylic acid, of adipic acid, dodecanedioic acid, terephthalic acid, and the like.

Advantageously, the composition of the invention comprises between 0.5 and 20% by weight, preferably between 1 and 10% by weight, of polyurethane, with respect to the weight of polyamide and polyurethane of the composition.

The composition of the invention can also comprise, in addition to the compounds A, B and optionally C, pore-forming agents which will make it possible to accentuate the phenomenon of foaming during the preparation of the foam from the composition. Such pore-forming agents are known to a person skilled in the art.

The expandable composition of the invention can also comprise other additives of use in the subsequent preparation of the foam, such as surfactants, nucleating agents, such as talc, plasticizers, and the like. These additives are known to a person skilled in the art.

The composition can also comprise reinforcing fillers, such as glass fibers, mattifying agents, such as titanium dioxide or zinc sulfide, pigments, dyes, heat or light stabilizers, bioactive agents, soil release agents, antistatic agents, flame retardants, high- or low-density fillers, and the like. This list is not in any way exhaustive.

Any method known to a person skilled in the art for preparing a composition can be used to prepare the composition of the invention comprising a polyamide A, a polyurethane B and optionally a compound C. It is possible, for example, to prepare an intimate blend of the powders of the various compounds. It is also possible to introduce the polyurethane into the molten polyamide. The blend can, for example, be produced in an extrusion device. The polyamide can also be provided in the form of granules, which are coated with polyurethane.

When the composition is prepared using an extrusion device, for example, the composition can subsequently be shaped into granules. These granules can subsequently be used as is to prepare the foam from the composition.

According to a specific embodiment of the invention, the composition is prepared by introducing the polyurethane into the molten polyamide, the temperature of the medium being chosen so as to prevent any significant release of gas. Advantageously, the temperature T(° C.) for preparation of the composition of the invention is greater than or equal to M.p.−30, preferably greater than or equal to M.p.−20 and more preferably still greater than or equal to M.p.−10, M.p. being the melting point (in ° C.) of the polyamide A of the composition. The temperature T(° C.) of preparation of the composition of the invention is preferably less than or equal to 275° C. In this case, the composition can be prepared in an extrusion device and can then be shaped into granules, for example. The granules obtained are expandable granules which can subsequently be introduced directly, for example, into a transformation and shaping device in which the polyamide foam of the invention is prepared. Advantageously, the composition of the invention, before stage a), is in the form of expandable granules.

The temperature to be achieved during the heating stage a) of the process of the invention has to be sufficient for there to be release of gas, generally carbon dioxide, and the formation of a cellular structure. Release of gas originates in particular from the reaction between the isocyanate functional groups and the carboxylic acid functional groups of the polyurethane and polyamide of the composition, and optionally, compound C. It also originates from the reaction between the isocyanate functional groups and the water present in the composition. The temperature and the kinetics of the reactions generating release of gas depend on the nature of the various constituents of the foam, that is to say of the polyurethane and polyamide, and of the presence or absence of catalysts.

The temperature to be achieved during the heating stage a) is greater than or equal to the melting point of the polyamide A of the composition. Advantageously, this temperature T′(° C.) is greater than or equal to T(° C.)+10, preferably greater than or equal to T(° C.)+15, T(° C.) being the temperature of preparation of the composition of the invention, described above.

Stage a) is generally carried out in the molten state. A device for transformation of plastic, such as an extrusion device, can be used during this stage.

The duration of stage a) varies according to the device used. A catalyst or a mixture of catalysts can be employed during this stage.

A catalyst can be used to accelerate the reaction for the decarboxylation of the carbamic and acid anhydride obtained by reaction of the acid functional group with the isocyanate functional group; mention may be made, as example, of tertiary amines, such as diazabicyclooctane (DABCO), diazabicycloundecene (DBU) or triethylamine.

The preparation of the composition of the invention and the preparation of the foam from this composition can be carried out simultaneously. They can be carried out in identical devices, such as an extrusion device.

Pore-forming agents can be introduced during stage a), and also surfactants, nucleating agents, such as talc, plasticizers, and the like.

Other compounds can also be introduced during stage a), such as reinforcing fillers, for example glass fibers, mattifying agents, such as titanium dioxide or zinc sulfide, pigments, dyes, heat or light stabilizers, bioactive agents, soil release agents, antistatic agents, flame retardants, and the like. This list is in no way exhaustive.

The stage b) of stabilization of the cellular structure can be obtained, for example, physically (for example by cooling to a temperature below the melting point or below the glass transition temperature of the polyamide) and/or chemically (by crosslinking the polyamide). Cooling is generally obtained by carrying out a quenching (rapid decrease in the temperature). The crosslinking of the polyamide can be carried out by addition of crosslinking agents known to a person skilled in the art. These are in general compounds comprising at least two functional groups which react with the acid and/or amine functional groups of the polyamide. Generally, these compounds comprise at least three reactive functional groups. Mention may be made, as example of crosslinking agents, of carbonylbis-lactams, such as carbonylbiscaprolactam, bisoxazine or bisoxazoline. Stage b) is advantageously carried out physically and by cooling.

The foam structure obtained can be shaped by employing a molding device, injection molding device, thermal forming or compressing device, for example of SMC (Sheet Molding Compound) type, injecting/blow molding device, extrusion device, extrusion/blow molding device, and the like.

The process of the invention thus provides a simple method for producing polyamide foam. This is because the polyamide foam can be obtained easily according to conventional conditions for the melt transformation of aliphatic polyamides, such as polyamide 6,6, and using conventional equipment. Furthermore, the foam can be obtained in situ without requiring the introduction of external compounds, and directly from the composition. Finally, this process, in particular by the use of polymeric materials (polyurethane and polyamide), makes it possible to obtain a foam exhibiting good mechanical properties.

The invention also relates to polyamide foams capable of being obtained by the process described above. Finally, the invention relates to the use of a composition comprising at least one polyamide and at least one polyurethane to prepare a polyamide foam. Everything which was described above relating to the composition of the invention applies identically to this composition. Advantageously, the composition of the invention is in the form of expandable granules.

Other details or advantages of the invention will become more clearly apparent in the light of the examples given below solely by way of indication.

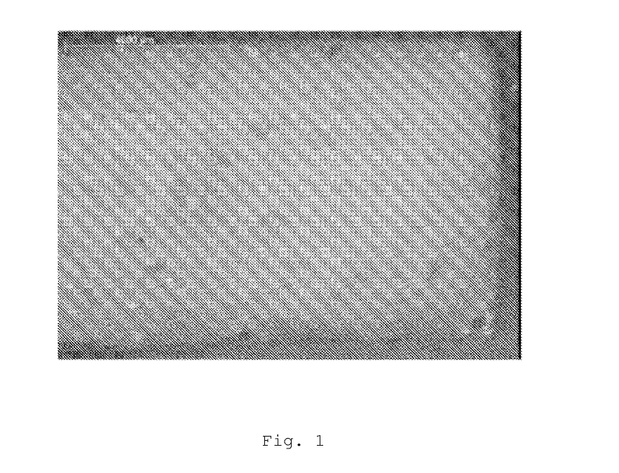

FIG. 1 represents a view in cross section of the foam of the invention, observed under an optical microscope.

### EXAMPLES

The contents of acid and amine end groups of the polyamides are quantitatively determined by potentiometry. AEG means: amine end groups; CEG means: carboxylic acid end groups.

The viscosity indices (VI) of the polyamides are measured from a 0.5% solution of polymer dissolved in 90% formic acid, according to the standard ISO EN 307.

### Example 1

### Manufacture of the Expandable Granules

The compounds used are as follows:
PA1: Polyamide 6,6 having a VI of 138 ml/g and comprising 1500 ppm of water. Contents of end groups: AEG=42 meq/kg, CEG=79 meq/kg.
PA2: Polyamide 6,6 having a VI of 163 ml/g and comprising 900 ppm of water. Contents of end groups: AEG=35 meq/kg, CEG=67 meq/kg.
PU1: Aliphatic thermoplastic polyurethane based on ε-caprolactone, sold under the name Krystalgran PN03-214 by Huntsman.
PU2: Aliphatic thermoplastic polyurethane based on polyester, sold under the name Krystalgran PN3429-218 by Huntsman.

The compositions are prepared by melt blending using a corotating twin-screw extruder of Thermo Prism type, model TSE16TC, exhibiting a length/diameter ratio of 25.

The compositions prepared and the extrusion conditions are described in detail in table 1. The proportions of the compounds are shown as percentage by weight in the composition.

The extruded compositions are cooled in water to ambient temperature and cut into the form of granules.

TABLE 1

| | Composition | Composition | Composition | |
|---|---|---|---|---|
| Compound | 1 | 2 | 3 | Composition 4 |
| PA1 | 90 | 90 | | |
| PA2 | | | 90 | 90 |
| PU1 | 10 | | 10 | |
| PU2 | | 10 | | 10 |
| Temperature | 259(die)- | 256(die)- | 255(die)- | 252(die)-271- |
| of the molten | 270- | 268- | 270- | 272-271 |
| polymer in | 257-263 | 256-263 | 268-265 | |
| the extruder | | | | |
| (° C.) | | | | |
| Rotational | 500 | 500 | 500 | 500 |
| speed | | | | |
| (revolutions/ | | | | |
| min) | | | | |
| Throughput | 2.6 | 2.6 | 2.7 | 2.7 |
| (kg/h) | | | | |
| Density of | 1.09 | 1.06 | 1.06 | — |
| the | | | | |
| expandable | | | | |
| granules | | | | |

The density of the polyurethane alone is 1.13. The density of the polyamide 6,6 alone was measured after extrusion on the same extruder; it is 1.11.

### Example 2

### Manufacture of Expanded Material Using an Extrusion Device

The foaming of the expandable granules of example 1 is carried out in the molten phase, using a corotating twin-screw extruder of Thermo Prism type, model TSE16TC, exhibiting a length/diameter ratio of 25.

The extrusion conditions and the densities obtained are summarized in table 2.

TABLE 2

| | Composition | |
|---|---|---|
| | Composition 1 | Composition 3 |
| Water content before | 1000 | 1100 |
| foaming (ppm) | | |
| Temperature of the | 246(die)-271-295-290 | 245(die)-271-293-288 |
| molten polymer in the | | |
| extruder (° C.) | | |
| Throughput (kg/h) | 2.0 | 1.6 |
| Rotational speed | 500 | 250 |
| (revolutions/min) | | |
| Density | 0.7 | 0.7 |

In both cases, the cellular distribution is of closed type.

### Example 3

### Manufacture of Expanded Articles Using an Injection Molding Device

The foaming of the expandable granules of example 1 is carried out in the molten phase, using a BOY 12M 129-18 injection molding machine from Bewe Plast with a mold of “plate” type with dimensions (in mm) of 80×10×4. The injection molding conditions and the densities obtained are summarized in table 3.

TABLE 3

| | Composition | |
|---|---|---|
| | Composition 1 | Composition 3 |
| Water content before | 1000 | 1100 |
| foaming (ppm) | | |
| Temperature profile | 300(nozzle)-295-295- | 300(nozzle)-295-295- |
| (° C.) | 275 | 275 |
| Maximum injection | 60 bar hydraulic | 60 bar hydraulic |
| pressure | | |
| Injection time (s) | 2.3 | 2.6 |
| Mold temperature (° C.) | 80 | 80 |
| Density | 0.75 | 0.84 |

In both cases, the cellular distribution is of closed type. A core/skin structure is observed having a gradient in cell sizes ranging from approximately 50 μm under the skin to approximately 1 mm at the core (see FIG. 1, which corresponds to composition 1), typical of a structural foam.

1. A process for the preparation of a polyamide foam, the process comprising at least the following stages:
a) heating a composition comprising at least the following compounds:
A: a polyamide
B: a polyurethane
optionally C: a compound comprising at least one acid functional group
at a temperature greater than or equal to the melting point of the polyamide A of the composition, and
b) stabilizing the cellular structure obtained.

2. The process as claimed in claim 1, wherein the polyamide is a polymer with a number-average molecular weight of greater than or equal to 10 000 g/mol.

3. The process as claimed in claim 1, wherein the polyurethane exhibits a number-average molecular weight of greater than or equal to 2000 g/mol.

4. The process as claimed in claim 1, wherein the polyamide is a linear polyamide.

5. The process as claimed in claim 1, wherein the polyamide is selected from the group consisting of polyamide 6, polyamide 6,6, polyamide 6,10, blends thereof and copolymers thereof.

6. The process as claimed in claim 1, wherein the polyamide is polyamide 6,6.

7. The process as claimed in claim 1, characterized in that wherein the composition comprises 0.5% to 20% by weight, of polyurethane, with respect to the weight of polyamide and polyurethane of the composition.

8. The process as claimed in claim 1, wherein stage b) is obtained physically.

9. A foam obtained by the process as claimed in claim 1.

10. An article obtained by shaping the foam obtained by the process as claimed in claim 1.

11. A method of preparing a polyamide foam, the method comprising preparing the foam with a composition described in claim 1.

12. The method as claimed in claim 11, wherein the composition is in the form of expandable granules.

13. The process as claimed in claim 1, wherein at least one acid functional group in the compound C is a carboxylic acid functional group.

14. The process as claimed in claim 2, wherein the number-average molecular weight is greater than or equal to 14,000 g/mol.

15. The process as claimed in claim 2, wherein the number average molecular weight is greater than or equal to 17,000 g/mol.

16. The process as claimed in claim 3, wherein the number-average molecular weight is greater than or equal to 5,000 g/mol.

17. The process as claimed in claim 3, wherein the number-average molecular weight is greater than or equal to 10,000 g/mol.

18. The process as claimed in claim 3, wherein the composition comprises 1% to 10% by weight of polyurethane.
